(19) United States
(12) Patent Application Publication
(10) Pub. No.: US 2009/0293923 A1
(43) Pub. Date: Dec. 3, 2009

(54) DETERGENT DISPENSING DEVICE

(75) Inventors: Alberto Buogo, Mira (IT); Andrea Marigo, Mira (IT); Emanuele Rossetto, Mira (IT); Giuseppe Di Bono, Mira (IT); Zefferino Righetto, Mira (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., WT HOOFDDORP (NL)

(21) Appl. No.: 12/300,371

(22) PCT Filed: May 11, 2007
(86) PCT No.: PCT/GB07/01727

§ 371 Date: Mar. 6, 2009

(30) Foreign Application Priority Data
May 18, 2006 (GB) 0609862.8

(51) Int. Cl. B08B 3/00; D06F 35/00

(52) U.S. Cl. 134/58 D; 68/17 R

(57) ABSTRACT

The present invention provides a detergent composition dispensing device. The device is removably insertable into a washing machine. The device comprises a chamber to accommodate a detergent composition, a detection means to detect the presence of water and/or wash liquor in the machine and a pumping means to pump the detergent composition from the chamber out of the device. The pumping means is influenced by an output signal from the detection means, characterised in that the detection means has an associated algorithm such that water is not deemed to have been detected until water and/or wash liquor has been detected as being present over a certain portion of a per-determined time interval in a wash cycle.

This application is filed under 35 USC 371 based on PCT/GB2007/001727.

The present invention is related to a detergent dispensing device, particularly for dispensing said detergent into an automatic washing machine over a plurality of cycles.

In automatic machines, the detergent, whether in powder, tablet or gel form, is usually filled manually by the user into the machine, in particular into a detergent holder, before each washing operation.

This filling process is inconvenient, with the problem of exact metering of the detergent and possible spillage thereof, for powder and gel detergents. Even with detergents in tablet form, wherein the problem of accurate dosing is overcome, there is still the necessity of handling the washing detergent every time a washing cycle is started. This is inconvenient because of the usually aggressive and irritant nature of detergent compositions, because of the time wasted in the operation and because of the need to store the detergent separately from the automatic machine.

A number of devices are known for holding unit doses of a detergent composition or additive, such as detergent tablets, and for dispensing of such unit doses into a machine. WO 01/07703 discloses a device for the metered release of a detergent composition or additive into a washing machine having a number of separate sealed chambers for holding the detergent composition or additive and means for piercing the chambers, activated by conditions within the machine. The reliable operation of this type of device is limited by the complication of the dispensing and indexing mechanism and by the variability of the actuation means described in the patent, like weight of the load or rotation of the drum.

WO 03/073906 discloses a free standing device for dispensing multiple doses of detergent into a dishwasher. The device has a plate-like construction. A round blister pack having a plurality of doses arranged around its periphery is loaded into the pack. A winder is then rotated to load mechanical energy into the device sufficient to dispense more than one dose of detergent. A thermally operated latch then moves when the device is subjected to the elevated temperatures within the dishwasher and, in cooperation with a ratchet mechanism, moves the blister pack so that the next dose of detergent is ready for dispensing. In order to dispense the detergent, either the blister pack is pierced, or the dose is ejected from its compartment within the blister pack.

WO 03/073907 discloses a similarly shaped free standing dispensing device. In order to dispense detergent, a lever is manually operated to move a blister pack either to eject the detergent from a compartment within the blister pack, or to pierce the blister pack. A door or flap initially prevents wash liquor within the machine from accessing the exposed detergent. A bi-metallic strip is provided to move the door or flap when the device is exposed to the elevated temperatures during a washing cycle to allow access of the wash liquor to the exposed detergent thereby dispensing the detergent to the machine.

Both these devices however suffer from serious shortcomings:
a) complicated dispensing and indexing mechanism,
b) they require the direct intervention of the user to operate, therefore reducing the time saved by using them
c) they depend on temperature for the dispensing of the dose and temperature gradients are not reliable triggers in laundry washing cycles, since the temperature of the wash can be selected by consumers between cold water and 90° C.

Other devices have been described such as in WO-02/29150 which measure a condition of the wash cycle and use this condition to trigger the release of a dose of a washing active, e.g. a washing detergent into a washing machine. One condition which is exemplified in this document is conductivity of the wash liquor, which can be used as an indication of the presence of water. However, the simple measurement of the presence of water is by no means a solution to the problem of the timing of the dose and the amount of dose of the washing active in the wash cycle. This is because false readings can occur, caused by, for example, dampness (wherein the dampness arises before the washing commences) of the washing being washed. Also in horizontal drum washing machines due to the level of fill of the drum with water and due to the rotation of the drum a device placed in a drum (and associated sensor), wherein the drum contains wash liquor, is not necessarily in contact with the wash liquor during all of the time. This can also give a false reading on the presence of water with associated incorrect detergent dosing.

The present invention is related to a development of these dispensing devices and overcomes the limitations described above.

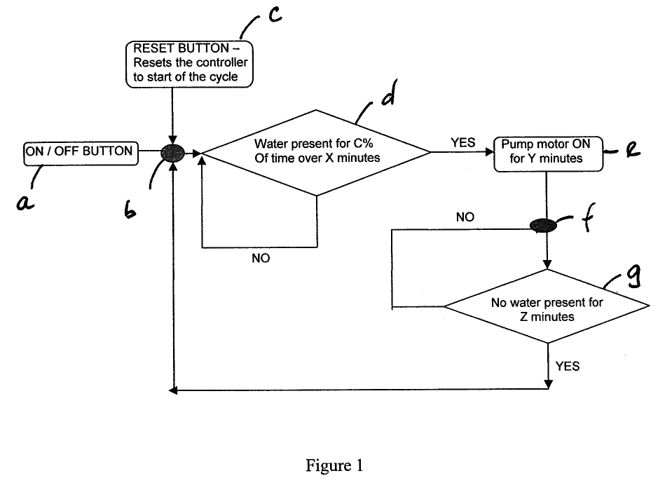

FIG. 1 illustrates a first series of process steps which may be used to control the operation of the detergent composition dispensing device according to the first aspect of the invention.

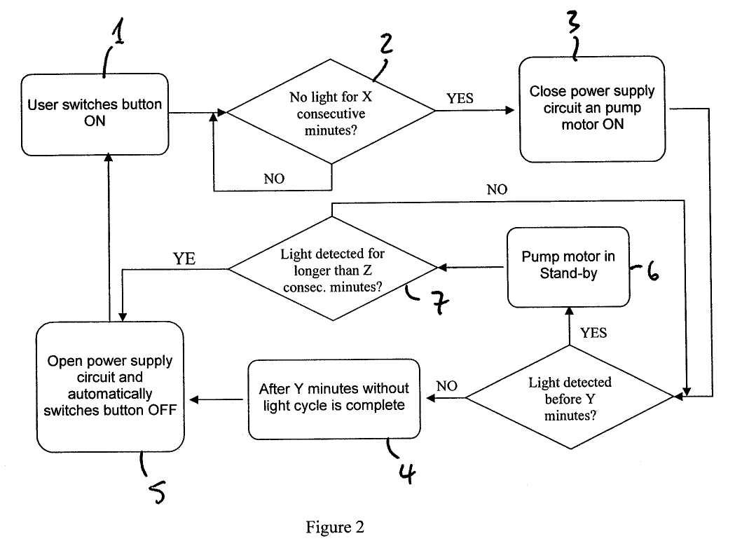

FIG. 2 illustrates a second series of process steps which may be used to control the operation of the detergent composition dispensing device according to the second aspect of the invention.

According to a first aspect of the present invention there is provided a detergent composition dispensing device adapted to be removably insertable into a washing machine, the said device comprising: a chamber to accommodate a detergent composition (or other fabric or textile treatment composition), a water detection means to detect the presence of water and/or wash liquor in the machine and a pumping means to pump the detergent composition from the chamber out of the device, wherein the pumping means is influenced by (responds to) an output signal from the water detection means, characterised in that the water detection means operates according to an associated algorithm (process step(s)) governing a controller means used to control the operation of the dispensing device such that water is not deemed to have been detected until water and/or wash liquor has been detected as being present over a certain portion of a predetermined time interval in a wash cycle. Additionally it has been found that the presence of wet items, e.g., fabric or the presence of any extraneous water or wet items during loading of the machine cannot trigger the dispensing device.

According to an alternate first aspect of the present invention there is provided a detergent composition dispensing device adapted to be removably insertable into a washing machine, the said device comprising: a chamber to accommodate a detergent composition (or other fabric or textile treatment composition), a water detection means to detect the presence of water and/or wash liquor in the machine and a dispensing valve means to release the detergent composition from the chamber out of the device, wherein the dispensing valve means is influenced by (responds to) an output signal from the water detection means, characterised in that the water detection means operates according to an associated algorithm (process step(s)) governing a controller means used to control the operation of the dispensing device such that water is not deemed to have been detected until water and/or wash liquor has been detected as being present over a certain portion of a predetermined time interval in a wash cycle. Additionally it has been found that the presence of wet items, e.g., fabric or the presence of any extraneous water or wet items during loading of the machine cannot trigger the dispensing device.

The present invention is advantageous because not only is the detergent dosed into the washing machine but also because the pump control system or dispensing valve means can be adapted to dose the proper quantity of detergent into the washing machine, especially into the washing liquor of the washing machine at the proper moment according to the requirements of the consumer operating the washing machine and the machine washing cycle which controls the mode of operation of the washing machine.

Preferably the dispensing device is for use in an automatic laundry washing machine.

It will be appreciated that the pre-determined time interval for which the dispensing device detects water in a laundry washing machine may need to be set or varied depending upon several factors relative to the laundry washing machine with which the dispensing device is used, including, for example, the length of the washing cycle of the washing machine, the brand of the washing machine, the type of the washing cycle, the type of “ballast” (type of fabric or garments in the washing machine, e.g., cotton, silk, synthetic textiles, delicate garments, etc.), the operating temperature(s) of the washing machine during the washing cycle (e.g., cold temperatures, to elevated temperatures, e.g. 90° C.), the number of rinse cycles occurring during the washing cycles (viz., older washing machines have higher number of rinse cycles than newer washing machines) and the nature of the detergent being dispensed into the washing machine, especially into the wash liquor used to treat the ballast. In a preferred embodiment the dispensing device additionally includes a further means (alert means) by which the sensor means and/or or pumping means can be alerted to take one or more of these factors into account.

As an example, some compositions, e.g. a water softening composition, should ideally be dosed into the laundry washing machine at a time relatively early within the washing cycle. In this case a pre-determined time interval of about 3-5 minutes preferably initiating from the start of the machine's main washing cycle is preferred. Alternatively for an additive, such as stain removal additive or other laundry treatment additive, should ideally be dosed into the laundry washing machine at a time relatively later in the washing cycle. In such a case, the pre-determined time interval may have to take into account the variance between different kinds of machine and washing cycle (as discussed above) but in any case would be longer than that for a water softening composition, e.g. for a stain removal additive or other laundry treatment additive could be about 15 minutes preferably initiating from the start of the machine's main wash cycle. Thus a preferred pre-determined time interval for such an additive, e.g. a stain removal additive or other laundry treatment additive, is in the range of 3-20 minutes, more preferably from 3-15 minutes, more preferably from 5-15 minutes preferably initiating from the start of the machine's main wash cycle.

Preferably the device is triggered to dispense detergent or other composition useful in the treatment of textiles, garments or other laundry articles according to the associated algorithm (process step(s)) when the device detects water in the machine for a period of between 5% and 20%, more preferably between 6% and 15%, more preferably between 7 and 12%, e.g. 8% of the pre-determined time interval.

The water detection means includes or has associated therewith a sensor means, which is desirably a suitable sensor which checks for the presence of water, and preferably checks for the presence of water when the sensor operates at a frequency of from 4-50 Hz, e.g. 10 Hz.

The controller means of a dispensing device of the invention may be any suitable device known to the art which may provide the functions described herein. Advantageously the controller means may include one or more of: a conventional general purpose, single- or multi-chip microprocessor such as Pentium processor, a conventional special purpose microprocessor, a system controller, integrated or non-integrated RAM memory controller, volatile or non-volatile memory, a power supply or power source, etc. Such may be suitably provided on a circuit board or packaged in one or more solidstate electronic devices, e.g., semiconductor devices. The controller means is suitably provided with communication means, e.g., wires or other signal transmission means to any sensor means present, as well being provided with suitable power and/or signal communication means, e.g., wires as to suitable further controller means and/or other elements of the dispensing device, e.g., motors, LEDs, valves, pumps, etc.

The algorithm may be programmed as a series of instruction steps into part of the controller means, e.g., a sequence of machine readable instructions steps, viz., a “program”, such as a low-level assembly language program, or a higher level interpreted or compiled computer programming language. Alternately the algorithm may be embodied as a special purpose analog control circuit present as part of the dispensing device.

The algorithm (process step(s)) may incorporate a second measurement means that checks for the absence of water for a defined time interval so to detect the end of the washing cycle program. This can be important as the dispensing device should preferably be able to dose at the correct time(s) of the washing cycle and be ready for dispensing in subsequent washing cycles. In a washing cycle there may be, and frequently are several “dry” periods (time interval(s)) (e.g. after the main wash and each rinse cycle) typically such “dry” periods occur during spin cycles of the washing cycle, viz., during spinning of the articles being treated. It is important that the control system used to control the operation of the dispensing device should not trigger a new dosing cycle by the device every time the sensor means detects incoming water after a dry cycle.

The alternative to such a water absence detection means is a “sleep mode”, wherein after the dispensing device has finished dosing the detergent or other composition into the correct part (steps(s)) or during the correct time(s) of the washing cycle it falls into a period of inactivity to ensure that no further detergent or other composition is dosed into an incorrect part (step(s)) or time(s) of the washing cycle. A possible problem with such a “sleep mode” is due to the variation in washing cycle length (as described above). If there is no detection of the end of a washing cycle, then to prevent incorrect dosing the device must go in “sleep” mode for a minimum time that is longer than the longest washing machine program cycle (otherwise in this case there would be 2 dosings delivered by the device in a wash cycle) but this could lead to a “lag” after a short program.

For example a typical long washing cycle program could be 2.5 hours; hence the time period of the sleep mode must be at least 2.5 hours (possibly with a slight variation to allow for the dosing time of the device and/or or to allow for the time taken to prepare a machine between washing cycles). In contrast a short program (e.g. for delicate fabrics or garments) could be only 1.5 hours. Thus if a sleep time of 2.5 hours is used then the dosing device would not be ready for the next cycle before the lapse of 1 hour. In this case the user must either reset the device or wait; otherwise the dosing will happen in a later step of the program when it could be detrimental.

Hence if such a sleep time function (process step(s)) is incorporated into the device it is preferably adjustable to take into account the variance between different washing cycle lengths.

The sensor means of the dispensing device may be any sensors may use conductivity, i.e. the conductivity the water and/or wash liquor present in order to determine the presence of water.

An example of a mode of operation (process steps; algorithm) of a dispensing device supplied to a laundry machine is as follows; such are also disclosed with reference to FIG. 1

1) An “on/off” button (a) of the dispensing device is activated by a consumer and manually switched “on” to initiate operation of a controller means, which also initiates the operation of the dispensing device, and places it in a “ready” state; such may be visually indicated by a suitable visual indicator means, e.g. a “green dot” (b) or other visually discernable marker on the dispensing device to indicate the operating status of the dispensing device, here that it is in a “ready” state.

1.1) If at any time the “on/off” button is switched “off” and then “on” again, the controller means restarts, and initiates the operation of the dispensing device anew, and places it in the “ready” state.

1.2) If at any time a “reset” button present on the dispensing device is pressed, the controller means restarts and goes back to the “ready” state and initiates the operation of the dispensing device anew, and places it in the “ready” state.

2) When water detection means (d) operates to indicate the presence of water in the washing machine for more than C % of time (see above), counted over the last X minutes of operation of the controller which counting is continuously updated by the controller by a sensor of the water detection means operating at a frequency of 4-50 Hz, preferably about 10 Hz, the sensor of the water detection means transmits a “water detected” signal to the controller means, and responsive thereto, the controller closes a power supply circuit to a pump present in the dispensing device thereby engaging or energizing the pump (e), and/or controls the operation of a dispensing valve present in the dispensing device in communication with a pressurised detergent chamber present in the dispensing device for Y minutes, thereby releasing a quantity of the contents of the chamber of the dispensing device into the interior of the washing machine, and thereafter the controller means enters a “waiting for end of cycle” state, such may be visually indicated by a suitable visual indicator means, e.g. a “red dot” (f) or other visually discernable marker on the dispensing device to indicate the operating status of the dispensing device, here that it is in a “waiting for end of cycle” state.

3) When the sensor of the water detection means (g) provides a suitable signal indicative of an “absence of water” in the washing machine (or part thereof) for more than the last Z minutes of operation of the controller means, which counting is continuously updated by the controller by a sensor of the water detection means operating at a frequency of 4-50 Hz, preferably about 10 Hz, the controller means revert to or enters a “ready” state; such may be visually indicated by a suitable visual indicator means, e.g. a “green dot” or other visually discernable marker, as discussed previously.

In a “ready state” the dispensing device is prepared for a new or next dispensing operation wherein a quantity of a detergent composition or other laundry treatment composition may be released from the chamber of the dispensing device into the interior of the laundry washing machine, preferably to the drum, water and/or washing liquor of the laundry washing machine such that the detergent composition or other laundry treatment composition comes into contact with the ballast being treated during the laundry treatment operation.

Most preferably the detergent or other treatment composition is dispensed from the chamber of the dispensing device during the main wash interval and/or the last rinse step interval of the washing cycle of the washing machine.

The foregoing sequence of process steps is to be understood as being illustrative and not limiting of the process and/or dispensing device described herein.

According to a second aspect of the invention there is provided a detergent dispensing device removably insertable into a laundry machine, the device comprising a chamber to accommodate a detergent or other textile treatment composition, a light detection means to detect the presence of light in the interior of the laundry machine and a pumping means to pump the detergent or other textile treatment composition from the chamber out of the device, wherein the pumping means is influenced by (responds to) an output signal from the light detection means, characterised in that the light detection means operates according to an associated algorithm (process step(s)) governing a controller means used to control the operation of the dispensing device such that light is not deemed to have been detected until light has been detected as being present within the laundry machine over a certain portion of a predetermined time interval in a laundry treatment cycle.

According to an alternative second aspect of the invention there is provided a detergent dispensing device removably insertable into a laundry machine, the device comprising a chamber to accommodate a detergent or other textile treatment composition, a light detection means to detect the presence of light in the interior of the laundry machine and a control valve means to release the detergent or other textile treatment composition from the chamber out of the device, wherein the control valve means is influenced by (responds to) an output signal from the light detection means, characterised in that the light detection means operates according to an associated algorithm (process step(s)) governing a controller means used to control the operation of the dispensing device such that light is not deemed to have been detected until light has been detected as being present within the laundry machine over a certain portion of a predetermined time interval in a laundry treatment cycle.

Preferably the laundry machine of the foregoing process is a laundry tumble dryer machine.

We have found that the device of the second aspect of the invention works particularly well in tumble dryers. It is postulated that this effective operation arises partly due to the darkness, which regulates the mode of operation of such tumble dryers can be obtained only in tumble dryers, having a solid metal door, and not in other washing machines, having a glass (or other transparent) door. Also using darkness instead of heat as “logic trigger” in this device allows its use also when the tumble dryer is used only for garment conditioning (done with an air flow at room temperature, while a temperature sensor would allow its use only when used as dryer.

An example of mode of operation (process steps; algorithm) of a dispensing device supplied to a tumble dryer is as follows; such are also disclosed with reference to FIG. 2:

A) An “on/off” button is activated (1) by a consumer and manually switched “on”, to initiate operation of a controller means, which also initiates the operation of the dispensing device.

A.1) If at any time if the “on/off” button is switched “off”, and then “on” again, the controller means restarts, and initiates the operation of the dispensing device anew, and places it in the “ready” state.

A.2) Light detection means of the dispensing device operates, preferably a sensor responsive to the absence or presence of light (such as a photoresistor or other suitable sensor) within the interior of the tumble dryer, reads the intensity of the light present within the tumble dryer. Desirably light detection means is a light sensor operating at a frequency between 10 and 1000 Hz, preferably between 50 and 500 Hz and more preferably between 75 and 250 Hz. As soon as the sensor indicates “no light” present in the interior of the tumble dryer for a pre-determined time period (2), it provides a “start” signal to the controller, and responsive thereto the controller of the dispensing device operates to closes a power supply circuit to the pump (or control valave means) present in the dispensing device there by engaging or energizing the pump (or opening the control valve means) (3) and/or a dispensing mechanism drive present in the controller and the controller continues to monitor the signal from the light detection means.

B.1) After a specific period with “no” light is sensed/determined by the light detection means and/or the controller (4), the controller causes the power supply circuit to open and causes the “on/off” button to be switched to the “off” position (5).

B.2) If the light detection means and/or the controller senses/determines the presence of light within the interior of the tumble dryer before the end of the period in (B.1) above, the controller operates to cause the pump motor of the pump present (or to cause the control vale means present) in the dispensing device into a “stand-by” state of operation (6).

B.3) If the presence of light within the interior of the tumble dryer is sensed/determined by the light detection means and/or controller for only a brief period then in darkness the controller re-starts and operates the pump means (or operates the control valve means) until the end of the period in (B.1) above (optionally taking into account any additional time interval for the period when presence of light was recorded).

B.4) If the presence of light within the interior of the tumble dryer is sensed/determined by the light detection means and/or controller is recorded for a long period, the controller causes the power supply circuit to interrupt and causes the “on/off” button to be switched to the “off” position (7).

It will be appreciated that the preferred features of the first aspects of the invention shall apply mutatis mutandis to the second aspect of the invention.

For both embodiments the pump means is preferably a micro pump powered by suitable source, e.g. batteries, or, more simply, the pump means may be a pressurised container closed by a control valve means, which may be any suitable valve which may be operated by the controller. Preferably the detergent composition leaves the device via an outlet, e.g., a pump outlet, the valve outlet or other outlet which may be present as part of the dispensing device. The outlet may be provided with a unit-directional valve to allow the unit-directional flow.

Preferably, the chamber is removable from the device to allow the chamber to be refilled and/or sold as a replaceable component which is inserted into the device.

Preferably the dispenser is removably connected to the side walls of the machine drum thanks to rubber plugs or to magnets or to similar connecting means.

Alternately the dispenser may be removably attached to the back plate of the drum or to the door of the machine by two suckers or to similar connecting means.

Alternatively the dispenser may be free to move in the drum.

The detergent most preferably comprises an automatic laundry detergent. Most preferably the detergent comprises a liquid. In the context of the present invention the term liquid can be taken to include solidified gels and/or suspensions as well as conventional liquids.

The detergent formulation typically comprises one or more of the following components; builder, co-builder, surfactant, bleach, bleach activator, bleach catalyst, enzyme, polymer, dye, pigment, fragrance, water and organic solvent.

Optionally the detergent comprises a detergent additive. It will be appreciated that a detergent additive when compared to a detergent may be required during a different section of the wash cycle (e.g. such as the rinse cycle for a rinse aid detergent additive).

Preferably the device includes an indicator means (indication mechanism) to indicate how much detergent remains within the chamber so that a consumer (user) can visually determine the remaining quantity of the detergent composition or other composition is present within the chamber or the dispensing device, and may optionally then assess when replacement of the detergent or other composition is required. A preferred form of an indicator means (indication mechanism) comprises a window on the chamber through which the detergent contents can be viewed by a consumer. The window may be marked with, for example, a series of numerals to ease judgement of how much detergent remains.

Optionally but desirably the dispensing device also includes an “end-of-life” indicator means to provide a visually discernible means to indicate when the contents of the chamber have been used. Normally the “end-of-life” indicator means provides two functions: firstly it high-lights to the consumer that the chamber needs replacing and secondly it prevents further activation of the cartridge.

The “end-of-life” indicator means may be a part of the indication means (indication mechanism) discussed above. Alternatively it may comprise a separate indicator.

Usually the “end-of-life” indicator means is reset when a new or replacement cartridge containing the detergent composition or other composition is provided to the dispensing device.

The deactivation of the “end-of-life” indicator means may be automatic or require manual input.

The present invention is illustrated with reference to the following non-limiting examples.

### EXAMPLE 1

### Performance Under Test Conditions

### Wash Conditions:—

| | |
|---|---|
| Water hardness: | 25° F. TAP |
| Temperature: | 40° C. |
| Wash cycle: | Cotton Cycle |
| Washing machine: | REX RI 95 CXI |
| Replications: | 4 |
| Load: | 3.5 kg of clean cotton ballast |

The dispensing device was set to dispense a laundry detergent; set with a pre-determined time interval of 5 minutes with a water detection level of 8% set as the trigger (8% of 5 minutes is 24 seconds).

| | Amount of time water detected (seconds) | | | | |
|---|---|---|---|---|---|
| | | In first | In first | In first | In first |
| | In first | two | three | four | five |
| Test | minute | minutes | minutes | minutes | minutes |
| 1 | 5 | 44 | 82 | 118 | 125 |
| 2 | 26 | 53 | 62 | 68 | 81 |
| 3 | 34 | 37 | 41 | 44 | 53 |
| 4 | 2 | 10 | 31 | 43 | 68 |
| 5 | 6 | 26 | 41 | 45 | 52 |
| 6 | 6 | 23 | 43 | 47 | 53 |
| 7 | 4 | 41 | 72 | 94 | 104 |
| 8 | 42 | 46 | 46 | 58 | 60 |
| 9 | 9 | 16 | 44 | 83 | 124 |
| 10 | 8 | 29 | 40 | 62 | 97 |

In each case the device was triggered to dose after a period of five minutes.

1. A detergent composition dispensing device adapted to be removably insertable into a washing machine, the said device comprising: a chamber to accommodate a detergent composition (or other fabric or textile treatment composition), a water detection means to detect the presence of water and/or wash liquor in the machine and a pumping means or dispensing valve means to release the detergent composition from the chamber out of the device, wherein the pumping means or dispensing valve means is influenced by (responds to) an output signal from the water detection means, characterised in that the water detection means operates according to an associated algorithm (process step(s)) governing a controller means used to control the operation of the dispensing device such that water is not deemed to have been detected until water and/or wash liquor has been detected as being present over a certain portion of a predetermined time interval in a wash cycle. Additionally it has been found that the presence of wet items, e.g., fabric or the presence of any extraneous water or wet items during loading of the machine cannot trigger the dispensing device.

2. A device according to claim 1, wherein the device is for use in an automatic laundry washing machine.

3. A device according to claim 1, wherein the pre-determined time interval for a laundry washing machine is between 3 to twenty minutes from the start of the washing cycle.

4. A device according to claim 3, wherein the device is triggered to dispense detergent when the device detects water in the machine for a period of from 5 to 20%% of the pre-determined time period.

5. A device according to claim 1, wherein the sensor checks for the presence of water at a frequency of from 4 to 50 Hz.

6. A device according to claim 1, wherein the algorithm incorporates a time delay after the dispensing phase.

7. A device according to claim 1, wherein the sensor tests for the conductivity of water and/or wash liquor present as an indication of the presence of water.

8. A device according to claim 1, wherein the detergent is dispensed in the main wash and/or the last rinse step of the washing cycle.

9. A detergent dispensing device removably insertable into a laundry machine, the device comprising a chamber to accommodate a detergent or other textile treatment composition, a light detection means to detect the presence of light in the interior of the laundry machine and a pumping means or control valve means to release the detergent or other textile treatment composition from the chamber out of the device, wherein the pumping means or control valve means is influenced by (responds to) an output signal from the light detection means, characterised in that the light detection means operates according to an associated algorithm (process step(s)) governing a controller means used to control the operation of the dispensing device such that light is not deemed to have been detected until light has been detected as being present within the laundry machine over a certain portion of a predetermined time interval in a laundry treatment cycle.

10. A device according to claim 9, wherein the device is for use in a laundry tumble dryer machine.

11. A device according to claim 9, wherein the pumping means is a micropump.

12. A device according to claim 9, wherein the pumping means is a pressurised detergent chamber closed by a control valve.

13. A device according to claim 1, wherein the chamber is removable from the device.

14. A device according to claim 9, wherein the chamber is removable from the device.
